(19) United States
(12) Patent Application Publication
(10) Pub. No.: US 2018/0150872 A1
(43) Pub. Date: May 31, 2018

(54) System for determining a subject advertisement's impressions and unique reach

(71) Applicant: RedPost, Inc., Goshen, IN (US)

(72) Inventors: Eric Kanagy, Goshen, IN (US); Kerry Oslund, Granger, IN (US)

(73) Assignee: RedPost, Inc., Goshen, IN (US)

(21) Appl. No.: 15/567,169

(22) PCT Filed: Apr. 14, 2016
(86) PCT No.: PCT/US16/27453

§ 371 Date: Oct. 17, 2017

Related U.S. Application Data
(60) Provisional application No. 62/148,893, filed on Apr. 17, 2015.

(51) Int. Cl. G06Q 30/02

(52) U.S. Cl. CPC G06Q 30/0246; G09F 27/00; G06Q 30/0259

(57) ABSTRACT

This system is a set of newsstands connected to cloud-based servers. Each newsstand has at least one monitor. The servers deliver advertisements to the newsstands, which in turn schedule and display these advertisements. The newsstands are equipped with wireless signal sniffers, which record the number and duration of wireless signals generated by a smartphone or tablet within range of the stands. The newsstands send their advertising schedules and signal records to the cloud-based servers, and these servers process the data to determine the number of unique and repeat viewers of each advertisement.

### CROSS-REFERENCE TO RELATED APPLICATIONS

This application claims priority to U.S. Provisional Patent Application 62/148,893, filed Apr. 17, 2015.

### BACKGROUND OF THE INVENTION

The science of marketing is centered on delivering advertisements to potential customers to entice them into buying the advertised product or service. The two central questions of marketing are (1) How many people does my advertisement reach?, and (2) Is this advertisement enticing?

Marketing research has developed a number of complex methods and surveys to try to answer the first question. However, a simple technical solution is still lacking.

### SUMMARY OF THE INVENTION

The invention is a system for delivering advertisements and measuring their reach. The delivery system is a newsstand topped with a monitor. The newsstand includes configurable shelves, a memory, a wireless signal sensor, and a connection to the Internet. The newsstand receives advertisements and their parameters from cloud-based servers through the Internet connection, as well as optional data. The newsstand's memory has software to create a schedule for displaying the advertisements, based on the advertisements' parameters and the optional data. The monitor will display the advertisements according to the schedule. While the advertisements are being displayed, the newsstand has software that receives raw data from the smartphone sensor and reformats that data into a useable format, storing in memory the number of detected mobile device signals, and for each signal, the wireless signal strength, and the length of time each wireless signal was within range. Separately, the newsstand has software that records a date and time stamp every time an advertisement is displayed on the screen, along with the advertisement's unique identifier (the Advertisement Play Log or APL). The memory has software to send the wireless signal data and advertisement play logs through the Internet connection to cloud-based servers.

There are several sets of cloud-based servers. The first set holds a database of the advertisements, their parameters, and any optional data that newsstands should factor into the creation of schedules. This set sends this advertising data to the appropriate newsstands.

The second set of cloud-based servers receives the wireless signal data and advertisement play logs from the newsstands and stores it in a database.

Optionally, the second set of servers (which may or may not be cloud-based) collect and store sales data tied to each newsstand location. Such data includes a unique location ID number, the name of the location, its address, its latitude-longitude (geocode), the type of product sold, the name of product sold, the price of product sold, and the sale's timestamp.

The third set of cloud-based servers send requests to the second set for the wireless signal data and advertisement play logs and optionally the sales data. This third set has software that matches wireless signal data to the advertisement play logs to determine which signals were present when an advertisement was displayed and which sales occurred. This software also produces estimates, based on field research, of the numbers of unique human viewers and of total human viewers of each advertisement on the schedule, whether those human viewers carried a wireless-enabled device or not. The software will also aggregate unique and total human viewers for each advertisement (regardless of the number of times it was displayed). The software may produce additional analytical data from the wireless signal data and advertisement play logs. This third set of servers transmits the newly-created data to the second set of servers, which stores this newly-created data in its database.

One aspect of this invention is a system for determining unique and total human viewers for a displayed advertisement, comprising:
at least one advertisement display, comprising:
   configurable shelves,
   at least one monitor,
   a wireless signal sensor,
   an advertisement display network connection,
   an advertisement display memory,
   an advertisement display processor having computer-readable instructions for:
      transmitting a request for advertisements in electronic file format and advertising schedules in electronic file format through the advertisement display network connection,
      receiving the advertisements and the advertising schedules through the advertisement display network connection,
      storing the advertisements and the advertising play logs in the advertisement display memory,
      generating a schedule of times to display the advertisements,
      transmitting the advertisements to the at least one monitor,
      receiving wireless signal records from the wireless signal sensor, each wireless signal record comprising a wireless signal ID, a starting time, and an ending time,
      storing the wireless signal records in the advertisement display memory, and
      transmitting the advertisement play logs and the wireless signal records through the advertisement display network connection;
an advertising server, comprising:
   an advertising server database comprising computer-readable memory having the advertisements in electronic file format and the advertising play logs in electronic file format;
   an advertising server network connection;
a data warehouse server, comprising:
   a data warehouse database comprising computer-readable memory, and
   a data warehouse network connection; and
a data analysis server, comprising:
   a data analysis network connection, and
   a data analysis processor having computer-readable instructions for:
      transmitting a request for the advertising play logs and the wireless signal records through the data analysis network connection,
      receiving the advertising play logs and the wireless signal records through the data analysis network connection,
      comparing the duration of the wireless signal in each wireless signal record to a minimum duration constant and deleting the wireless signal records with durations shorter than the minimum duration constant,
      comparing the starting time and ending time of each remaining wireless signal record to the advertising play logs to determine the number of relevant wireless signals proximate to the display location during each advertisement,
      for each advertisement, multiplying the number of relevant wireless signals by an adjustment value, thereby generating an advertisement reach value, and
      transmitting the advertisement reach value through the second server network connection to the first server.

Another aspect of this invention is the system described above, wherein the at least one advertisement display is at least one newsstand.

Another aspect of this invention is the system as described in any aspect above, wherein the computer-readable instructions of the advertisement display processor further comprise:
comparing the starting time and ending time of each wireless signal record to the advertising play logs to determine the number of relevant signals proximate to the display location during each advertisement.

Another aspect of this invention is the system as described in any aspect above, wherein the advertising server database further comprises:
identity data of factors to include in schedule formation, and
URLs where the values of the factors are found;
wherein the advertisement display processor has further computer-readable instructions for:
   transmitting a request to the advertising server database for the identity data of the factors and the URLs where the values of the factors are found through the advertisement display network connection,
   receiving the identity data and the URLs through the advertising display network connection into the advertising display processor,
   storing the identity data and the URLs in the advertising display processor,
   transmitting a request to each URL for the value of the factor located at the URL,
   receiving the values through the advertisement display network connection; and
      wherein the computer-readable instruction of generating a schedule of times to display the advertisements includes calculating the relative importance of the advertisements compared to the values of the factors.

Another aspect of this invention is the system as described in any aspect above, further comprising:
a data display computer comprising:
   a data display output device,
   a data display network connection,
   a data display processor having computer-readable instructions for:
      transmitting a request for data from the data storage warehouse through the data display network connection,
      receiving the data from the data storage warehouse,
      formatting the data from the data storage warehouse for display, and
      transmitting the formatted data from the data storage warehouse to the data display output device.

Another aspect of this invention is the method of measuring the number of viewers of a video advertisement, the advertisement being displayed by a display location comprising
configurable shelves,
at least one monitor,
a wireless signal sensor,
an advertisement display network connection,
an advertisement display memory, and
an advertisement display processor;
   the method comprising:
requesting one or more video advertisements from an advertisement database through the
advertisement display network connection,
receiving the one or more video advertisements into the advertisement display processor through the advertisement display network connection,
generating by the advertising display processor a schedule to display the one or more video advertisements,
storing the one or more video advertisements and the schedule in the advertisement display memory,
in accordance with the schedule, displaying by the at least one monitor a video advertisement,
during the displaying of the video advertisement, recording wireless signal data for each wireless signal in proximity to the display location by the wireless signal sensor, the wireless signal data comprising a signal ID,
during the displaying of the video advertisement, storing in the advertisement display memory play logs, each play log comprising identity data of the advertisement, the starting time of the advertisement, and the ending time of the advertisement,
calculating by the advertising display processor a starting time and an ending time for the proximity of each wireless signal,
assembling wireless signal records by the advertising display processor for each wireless signal ID, each wireless signal record comprising the signal data, the starting time, and the ending time for each wireless signal ID,
storing the wireless signal records in the advertising display memory, transmitting the wireless signal records and the play logs through the advertising display network connection to a first server comprising:
   a first server database comprising computer-readable memory, and
   a first server network connection,
transmitting a request for the wireless signal records and the play logs to the first server database from a second server comprising
   a second server processor, and
   a second server network connection,
receiving the wireless signal records and the play logs from the first server through the second server network connection into the second server processor,
deleting by the second server processor the wireless signal records having a difference between the starting time and the ending time shorter than a minimum duration value, comparing by the second server processor the starting time and ending time of each remaining wireless signal record to the play logs to determine the number of relevant wireless signals proximate to the display location during each advertisement, for each advertisement, multiplying by the second server processor the number of relevant wireless signals by a sensor adjustment value, thereby generating an advertisement reach value, and
transmitting the advertisement reach value through the second server network connection to the first server.

Another aspect of the invention is the method as described above, wherein the advertisement display location is a newsstand.

Another aspect of the invention is the method as described in any aspect above, further comprising:
comparing by the advertising display processor the starting time and ending time of each wireless signal record to the play logs to determine the number of relevant wireless signals proximate to the display location during each advertisement.

Another aspect of the invention is the method as described above, wherein the advertisement database further comprises:
identity data of factors to include in schedule formation, and
URLs where the values of the factors are found;
   the method further comprising:
transmitting a request for the identity data of the factors and the URLs where the values are found,
receiving the identity data and the URLs,
storing the identity data and the URLs in the advertisement display memory,
transmitting a request to each URLs for the values of the factors, and
receiving the values of the factors;
   and wherein the step of generating by the advertising display processor a schedule to display the one or more video advertisements includes calculating the relative importance of the advertisements compared to the values of the factors.

Another aspect of the invention is the method as described in any aspect above, further comprising:
transmitting a request for data from the first server,
receiving the data from the first server,
formatting the data for display, and
transmitting the formatted data to a data display output device.

### BRIEF DESCRIPTION OF THE DRAWINGS

FIG. 1 is an overview of the parts of the invented system and their interactions.

FIG. 2 is an isometric view of a newsstand, the preferred embodiment of a display location.

FIG. 3 shows the display location requesting and receiving advertisement schedules from the cloud.

FIG. 4 shows wireless-capable devices in proximity to a display location during the display of an advertisement.

FIG. 5 is a plan view of the rear of a newsstand, the preferred embodiment of a display location FIG. 6 shows the display location transmitting the data it collects during the display of advertisements to cloud-based servers.

FIG. 7 shows the DPP requesting and receiving the data collected by the display locations from cloud-based servers.

FIG. 8 shows the filtering process for determining the number of relevant wireless signals in proximity to a display location during the display of an advertisement.

FIG. 9 shows the process of translating the data collected by the display locations into estimates of the number of actual viewers.

### DETAILED DESCRIPTION OF THE INVENTION

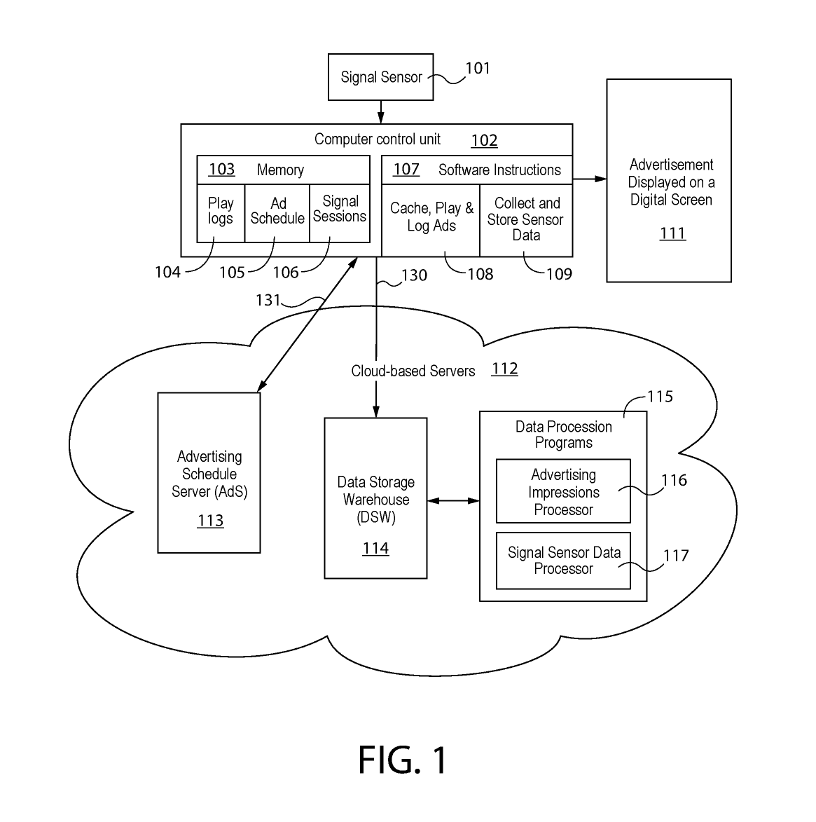

FIG. 1 shows an overview of the various parts of the system. The system is a combination of a series of display locations, each having at least one display screen 111, with cloud-based servers and databases 112. In preferred embodiments, the display locations are newsstands with one monitor attached. Each display location has at least one display screen 111, a Computer Control Unit (“CCU”) 102, an Internet connection 130, 131, and a Signal Sensor 101. The display location is connected via the Internet 130, 131 with several cloud-based services 112: a set of databases called the Data Storage Warehouse (“DSW”) 114, a set of databases called the Advertisement Schedule Server (“AdS”) 113, and a set of processors and software called the Data Processing Programs (“DPP”) 115. The DPP 115 includes an Advertising Impressions Processor 116 and a Signal Sensor Data Processor 117.

FIG. 1 also shows the Computer Control Unit 102 integral to each display location. The CCU has a computer-readable memory 103 to store play logs 104, ad schedules 105, and signal sessions 105. The CCU has software instructions 107 to cache, display, and log video advertisements 108 and to collect and store sensor data 109. These will discussed in greater detail below.

The AdS 113 is a computer-readable memory that stores advertisement scheduling data. Each schedule includes:
a unique advertisement identifier,
the duration of the advertisement,
a range of dates and times during which to display the advertisement. The range may be a single day, or it may repeat daily, weekly, monthly, or annually. The display locations show the advertisement at least once during the range, and often several times. For example:
   one time schedule:
      start time: Tuesday July 29, 12:00 am
      end time: Tuesday July 29, 11:59 pm
   repeating schedule:
      every Tuesday 12:00 am to 11:59 pm
other specific instructions, including which monitors the display location should exclude or include when displaying an advertisement,
a numerical priority ranking of each advertisement, specifying which advertisements should be played more or less frequently
a category of advertisement
one or more links to the graphics files, which may contain images, video, animation files, text, styles sheet, and HTML.

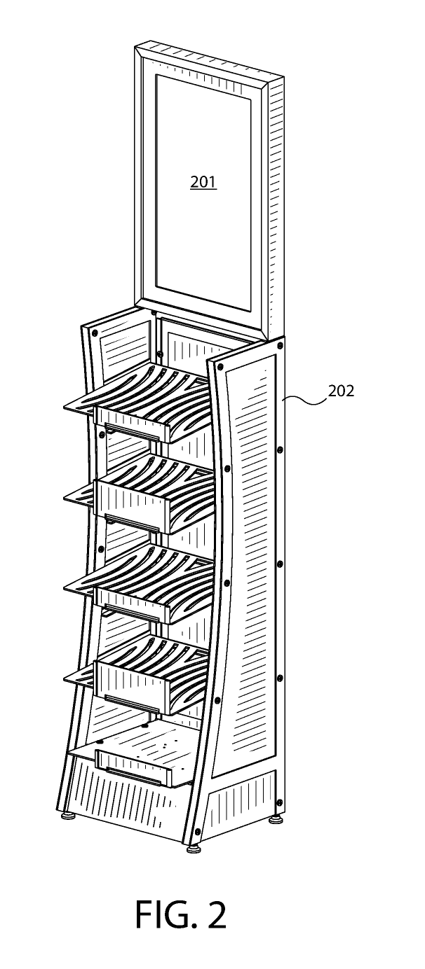

FIG. 2 shows a preferred embodiment of a display location. In this embodiment, the display location is a newsstand 202 with a monitor 201 attached. The newsstand also includes a network connection and a wireless signal sensor. The network connection, wireless signal sensor, and monitor are connected to the display location's CCU. The CCU is located behind the monitor. In alternative embodiments, the display location has more than one monitor. These monitors may share a CCU, or each monitor may have a dedicated CCU. In any embodiment, the display location may use any video display technology known in the art.

Returning to FIG. 1, the Computer Control Unit 102 includes one or more processors and computer-readable memory 103, and is equipped with operating software (“The Player”) 107. In preferred embodiments, The Player is written in Transparent Reactive Programming format, as defined by the Meteor open source software package, and the CCU uses the Linux operating system. In alternative embodiments, the CCU may use the Android operating system. Each CCU has a unique ID number to identify it throughout the system. Upon booting, the CCU opens a web socket to the AdS via the display location's network connection. The CCU then sends a request to the AdS for the most recent version of The Player, which the AdS, in turn, sends to the CCU. The CCU then stores the newest version of The Player in its memory and activates The Player.

The Player includes an HTML-and-CSS-based layout defining where the display location's monitors display key elements. These key elements may include the name of the geographic location of the display location, the current date and time, and the colors and branding of the display location. The Player also includes
a module for requesting and storing advertisement scheduling data,
the identity of additional data to display, such as Twitter feeds, transit data, breaking news feeds, and current weather,
the Internet locations to request or search for the additional data,
instructions defining how often to update scheduling and additional data,
the times to display advertisements within particular categories and numerical priorities,
any interrupting data sources that should be displayed instead of advertisements, such as emergencies, catastrophes, and similar events.

The Player will be updated periodically, and new versions will be sent to each display location from the AdS.

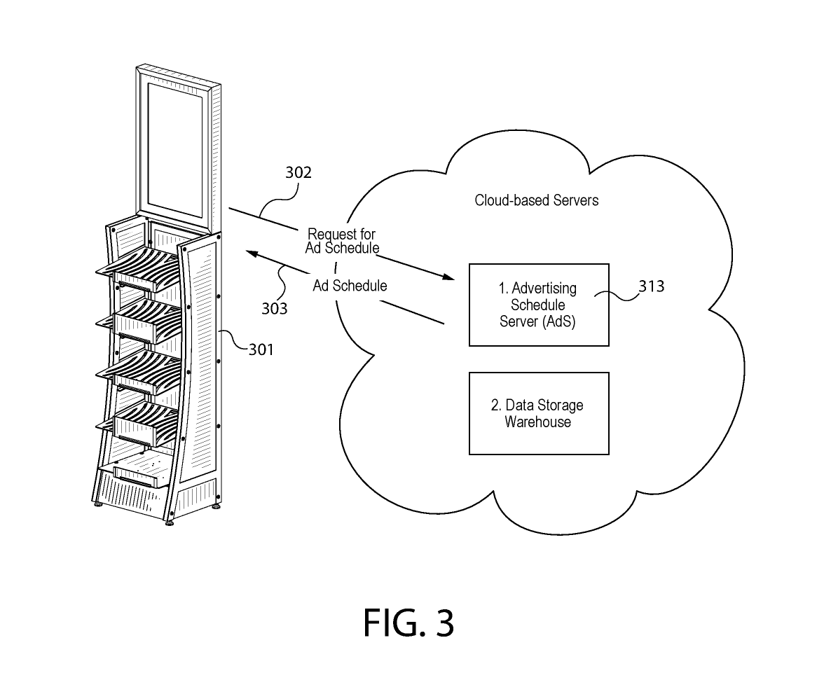

As shown in FIG. 3, once activated, the Player sends a new request 302 from its display location 301 to the AdS 313 for advertisement scheduling data via the web socket connection. The AdS 313 determines what set of schedules are to be delivered to the CCU at this date and time and transmits those schedules 303 back to the display location 301 via the web socket connection. The Player stores the scheduling data in the CCU's physical memory.

In preferred embodiments, the CCU and AdS maintain a constant connection over the network using the open source Distributed Data Protocol (“DDP”) websocket protocol, enabling real-time updating of the schedules stored in the CCU's memory. These sockets handle the communication between the CCU and the AdS. If the CCU loses Internet connectivity or the web socket disconnects, the DDP protocol includes a robust re-establishment regime to reconnect the web socket connection.

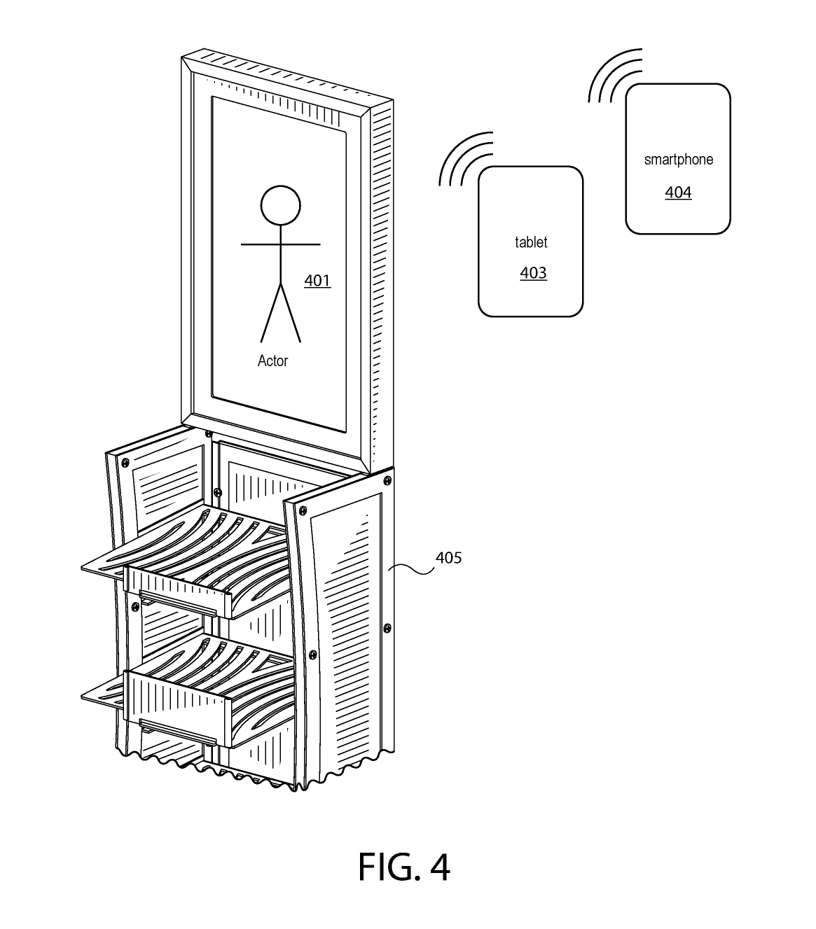

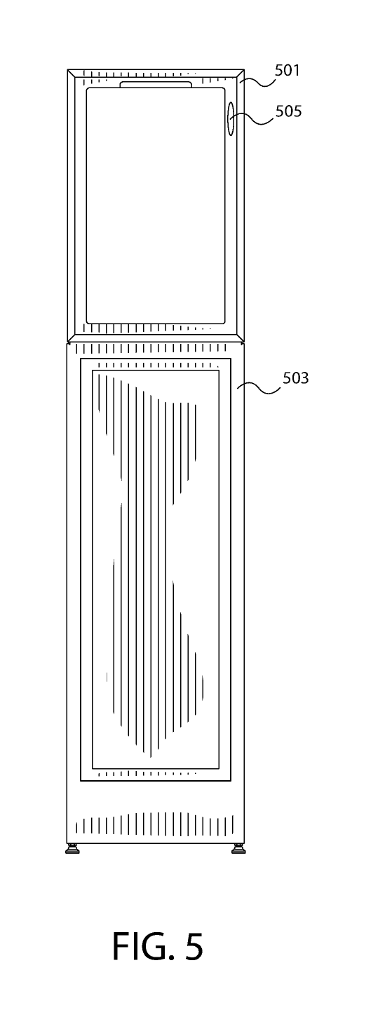

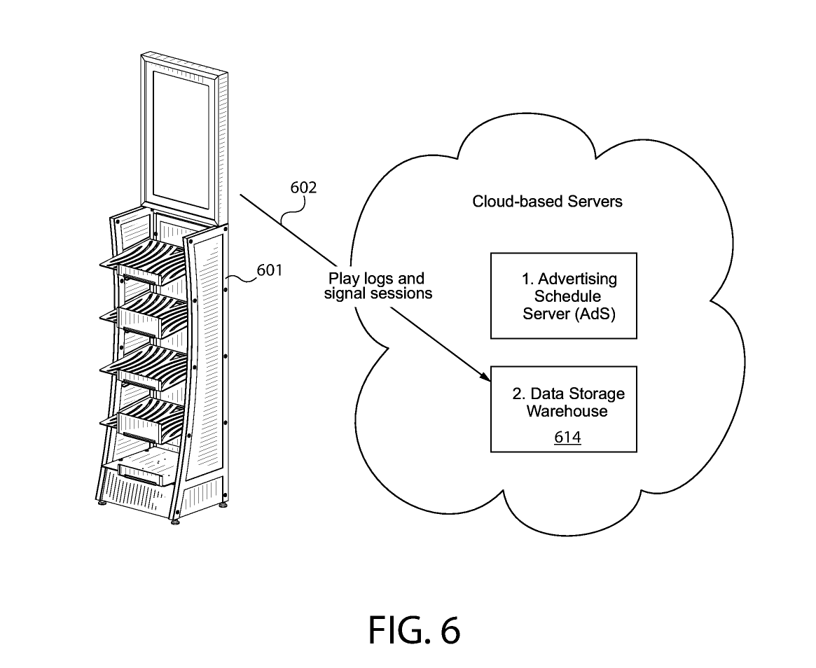

As shown in FIG. 4, a Signal Sensor connected to the CCU of the display location 405 continually scans the environment for signals from all Wi-Fi- or Bluetooth-enabled devices, such as a tablet 403 or smartphone 404. As shown in FIG. 5, in preferred embodiments, the Signal Sensor 505 is located on the back of the frame 501 of the display location 503. In preferred embodiments, the Signal Sensor will implement the IEEE 802.11 standard for wireless communication. Optionally, the Signal Sensor may also implement the IEEE 802.15 standard for wireless communication or other signals emitted by personal electronic devices in the ultra high frequency (UHF) bands, generally between 300 MHz and 3 GHz. The CCU includes software to operate the Signal Sensor. When the Signal Sensor senses a wireless signal, it records the signal's arrival time, departure time, and unique signal identifier. It may also record additional signal data. The combination of a unique signal identifier, a single arrival time, and a single departure time (combined with any additional data) forms a single Signal Session.

When the display location displays an advertisement on its monitor 401, the Player records the advertisement's unique identifier and its display start and end times, generating an Advertising Session data record. The CCU stores the Advertising Sessions data records in the Play Logs in the display location's memory.

As shown in FIG. 6, the CCU periodically sends these Signal Sessions and play logs 602 to the cloud-based Data Storage Warehouse 614. The Data Storage Warehouse is a cloud-based set of databases. The DSW may use any of a variety of data storage and recall methods, including comma-separated text files, the MongoDB open source database protocol, and Amazon's RedShift database protocol. The choice of database technology and the design of the databases are optimized to scale to billions of records.

The Data Processing Programs are a set of software programs hosted on cloud-based servers. In preferred embodiments, these programs are written in the Talend open source software protocol. These programs process the data stored in the Data Storage Warehouse, sending and receiving data to the DSW via a network.

One of the DPP's programs is the Signal Sensor Data Processor (“SSDP”). The SSDP filters newly-received Signal Session data to:
flag extraneous sessions fitting certain exclusion criteria, for example, if a wireless device appears for 24 hours every day, it is a resident device and should not be counted.
flag sessions that are too short in duration to meet the predefined minimum duration to qualify as an advertising impression. The minimum duration is a variable set by the system administrator.

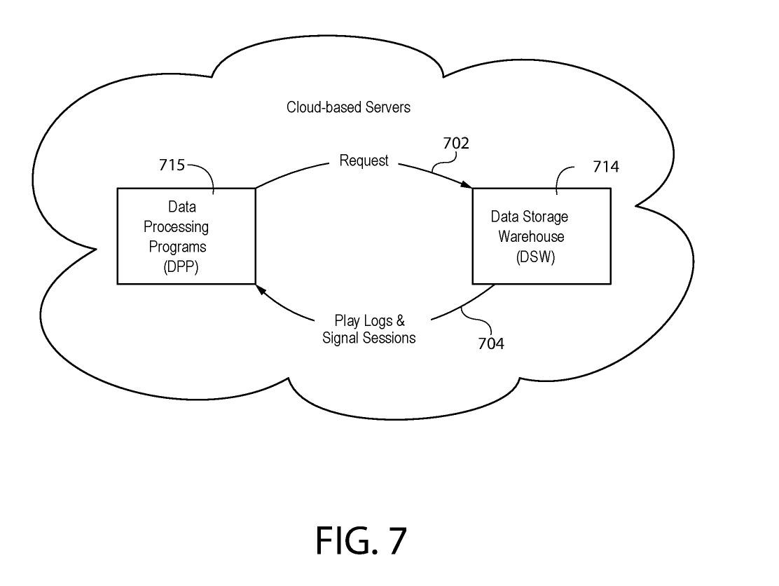

As shown in FIG. 7, the DPP 715 sends requests 702 to the DSW 714 for the play logs containing the Advertising Sessions and for the Signal Sessions. In preferred embodiments, the DPP requests the play logs containing the Advertising Sessions and the Signal Sessions 702 by day and CCU unique id. After receiving the Advertising Sessions and the Signal Sessions 704, the AIP stores them in computer-readable memory.

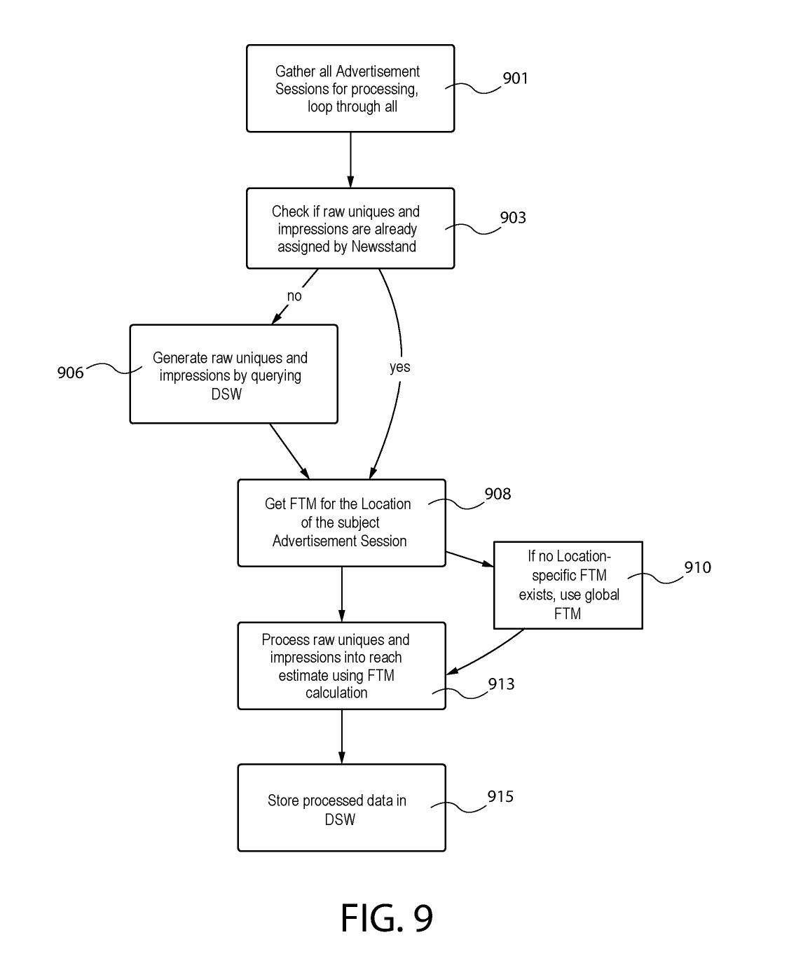

As shown in FIG. 9, after the DPP receives these Advertising Sessions and Signal Sessions 901, the DPP determines if the Signal Session filtering process has been carried out by the display location 903. If not, the DPP will filter the Signal Sessions to determine the number of unique wireless signals in proximity to the display location 906.

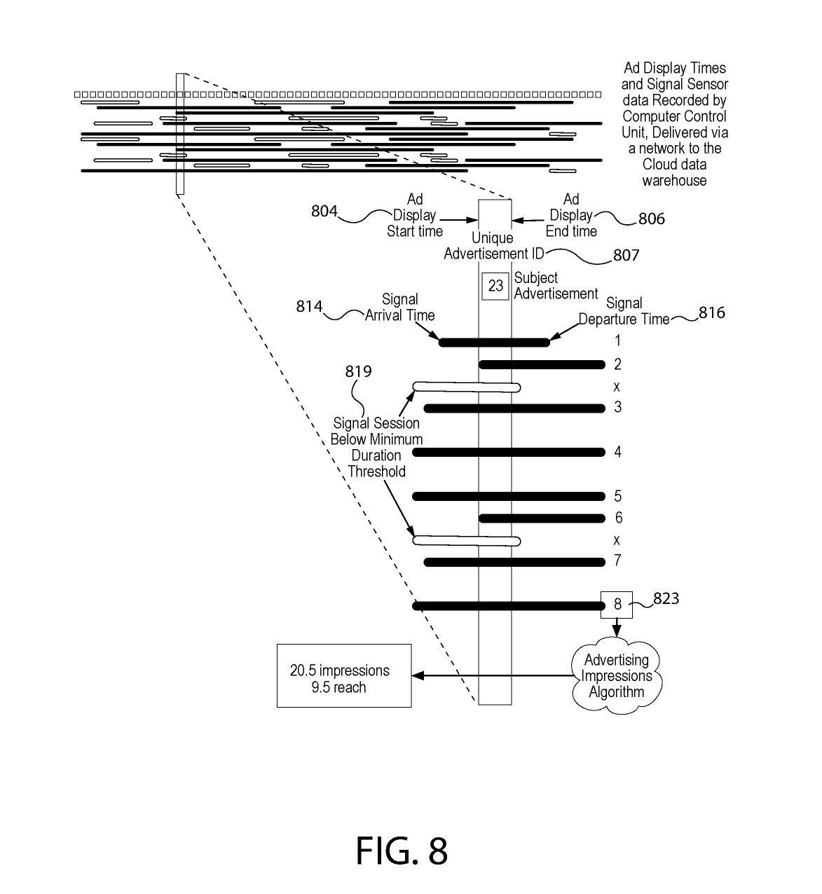

The filtering process 906 is shown in more detail in FIG. 8. The AIP compares the duration of each Signal Session to a minimum duration value, discarding those Signal Sessions that are shorter than the minimum duration value 819. By comparing the start time 814 and stop time 816 of each Signal Session to the subject Advertising Session's start time 804 and stop time 806 and to the previous start and stop time of the most recent Advertising Session with a particular Advertising ID 807, the AIP calculates the number of relevant Signal Sessions present during an Advertising Session 823. The AIP further distinguishes between unique Signal Sessions (reach) and repeat Signal Sessions (impressions) that have previously viewed the subject advertisement by examining the start and stop time of each Signal Session. If a Signal Session began after the subject advertisement last played, the session in question is unique. If the Signal Session began before the subject advertisement last played, the session is a repeat.

### AIP Algorithm:

Aₛ=Subject advertisement display start time
Aₑ=Subject advertisement display end time
Aₚ=Subject advertisement last played display end time

### Sᵤ=Unique Signal Sessions

### Sₜ=Total Signal Sessions

W=set of all Signal Sessions, after SSDP filtering
Sᵤ=W(session start time>=Aₚ AND session start time<=Aₛ AND session end time>=Aₑ)
Sₜ=W(session start time<=Aₛ AND session end time>=Aₑ)

The Signal Sensor detects only a portion of the total population carrying a device that emits the wireless signal being detected by the sensor. To generate an accurate estimate of actual foot traffic, the AIP includes Foot Traffic Multiplier (“FTM”) algorithms to produce a very close estimate of the number of unique people who viewed the subject advertisement (reach) and of the total number of times people viewed the subject advertisement (impressions).

RedPost combines online, in-person and industry research to calculate a nationwide FTM value and to understand signal penetration in various locations for each type of signal. Due to demographic differences, signal penetration is likely to vary from one location to the next. The FTM uses location-specific data to tailor a location-specific FTM value. Signal penetration is likely to change over time, and RedPost will periodically update its location-specific data as marketing research continues.

The FTM algorithms are as follows:

### Step 908

Cₘ=Actual Foot Traffic in a particular display location over a defined time period
C_{w}=Signal Sessions counted by a particular display location over a defined time period
Fₘ=Foot Traffic Multiplier for a display location

$$\frac{{C}_{m}}{{C}_{w}} = {F}_{m}$$

### Step 910

Pₛ=Fraction of people possessing wireless devices in the US (updated quarterly)
P_{w}=Fraction of people possessing wireless devices in the US who enable their wireless access (updated quarterly)
F=nationwide Foot Traffic Multiplier

$$\frac{1}{{P}_{s} {xP}_{w}} = F$$

Sᵤ=Unique Signal Sessions recorded by a display location during an Advertising Session
n=Number of Advertising Sessions for an advertisement across all display locations
Fₘ=Foot Traffic Multiplier for a newsstand location
Pᵣ=Reach of the advertisement (unique viewers of an advertisement across all display locations)

### Sₜ=Total Signal Sessions

P₁=Total number of impressions (total viewers of an advertisement across all display locations)

### Step 913

Total reach (number of people who saw an advertisement at least once, regardless of the number of times they saw the advertisement) for a single subject advertisement:

Pr=Sₜ₁Fₘ+Sᵤ₂Fₘ+ . . . +SᵤₙFₘ

Total impressions (number of times all people in all locations saw an advertisement) for a single subject advertisement:

Pᵢ=Sₜ₁Fₘ₁+Sₜ₂Fₘ₂+ . . . +SₜₙFₘₙ

The AIP aggregates data from individual Advertising Sessions and other sources to derive additional analytics, including:
charts of impressions and reach by hour of day, day of week, week of month, etc.,
impressions and reach by individual location and across all locations,
number of newsstand locations that displayed the advertisement,
geographic distribution of advertisement impressions and reach,
products sold by location and time of day.

The AIP sends the reach and impression data, and these additional analytics, via a network to the Data Storage Warehouse, which stores the data on its database 915.

We claim:

1. A system for determining unique and total human viewers for a displayed advertisement, comprising:
at least one advertisement display, comprising:
configurable shelves,
at least one monitor,
a wireless signal sensor,
an advertisement display network connection,
an advertisement display memory,
an advertisement display processor having computer-readable instructions for:
transmitting a request for advertisements in electronic file format and advertising schedules in electronic file format through the advertisement display network connection,
receiving the advertisements and the advertising schedules through the advertisement display network connection,
storing the advertisements and the advertising schedules in the advertisement display memory,
generating a display schedule in electronic file format for the advertisements, transmitting the advertisements to the at least one monitor,
receiving wireless signal records from the wireless signal sensor, each wireless signal record comprising a wireless signal ID, a starting time, and an ending time,
storing the wireless signal records in the advertisement display memory, and
transmitting the display schedule and the wireless signal records through the advertisement display network connection;
an advertising server, comprising:
an advertising server database comprising computer-readable memory having the advertisements in electronic file format and the display schedules in electronic file format;
an advertising server network connection;
a data warehouse server, comprising:
a data warehouse database comprising computer-readable memory, and
a data warehouse network connection; and
a data analysis server, comprising:
a data analysis network connection, and
a data analysis processor having computer-readable instructions for:
transmitting a request for the display schedules and the wireless signal records through the data analysis network connection,
receiving the display schedules and the wireless signal records through the data analysis network connection,
comparing the duration of the wireless signal in each wireless signal record to a minimum duration constant and deleting the wireless signal records with durations shorter than the minimum duration constant,
comparing the starting time and ending time of each remaining wireless signal record to the display schedules to determine the number of relevant wireless signals proximate to the at least one advertisement display during the display of each advertisement,
for each advertisement, multiplying the number of relevant wireless signals by an adjustment value, thereby generating an advertisement reach value, and
transmitting the advertisement reach value through the data analysis network connection to the data warehouse server.

2. The system of claim 1, wherein the at least one advertisement display is at least one newsstand.

3. The system of claim 1, wherein the computer-readable instructions of the advertisement display processor further comprise:
comparing the starting time and ending time of each wireless signal record to the display schedule to determine the number of relevant signals proximate to the at least one advertisement display during the display of each advertisement.

4. The system of claim 1, wherein the advertising server database further comprises:
identity data of factors to include in schedule generation, and
URLs where the values of the factors are found;
wherein the advertisement display processor has further computer-readable instructions for:
transmitting a request to the advertising server database for the identity data of the factors and the URLs where the values of the factors are found through the advertisement display network connection,
receiving the identity data and the URLs through the advertising display network connection into the advertising display processor,
storing the identity data and the URLs in the advertising display memory,
transmitting a request to each URL for the value of the factor located at the URL, receiving the values through the advertisement display network connection; and
wherein the computer-readable instruction of generating a display schedule for the advertisements includes calculating the relative importance of the advertisements compared to the values of the factors.

5. The system of claim 1, further comprising:
a data display computer comprising:
a data display output device,
a data display network connection,
a data display processor having computer-readable instructions for:
transmitting a request for electronic data from the data storage warehouse through the data display network connection,
receiving the data from the data storage warehouse,
formatting the data from the data storage warehouse for display, and
transmitting the formatted data from the data storage warehouse to the data display output device.

6. A method of measuring the number of viewers of a video advertisement, the advertisement being displayed by an advertisement display comprising:
configurable shelves,
at least one monitor,
a wireless signal sensor,
an advertisement display network connection,
an advertisement display memory, and
an advertisement display processor;
the method comprising:
requesting at least one video advertisement from an advertisement database through the advertisement display network connection,
receiving the at least one video advertisement into the advertisement display processor through the advertisement display network connection,
generating by the advertising display processor a display schedule for the at least one video advertisement,
storing the at least one video advertisement and the display schedule in the advertisement display memory,
in accordance with the display schedule, displaying by the at least one monitor a video advertisement,
during the displaying of each video advertisement,
recording wireless signal data for each wireless signal in proximity to the display location by the wireless signal sensor, the wireless signal data comprising a signal ID,
calculating by the advertising display processor a starting time and an ending time for the proximity of each wireless signal, AND
storing in the advertisement display memory play logs, each play log comprising identity data of the advertisement, the starting time of the advertisement, and the ending time of the advertisement,
for each signal ID, assembling wireless signal records in electronic file format by the advertising display processor, each wireless signal record comprising the signal data, the starting time, and the ending time,
storing the wireless signal records in the advertising display memory,
transmitting the wireless signal records and the play logs through the advertising display network connection to a first server comprising:
a first server database comprising computer-readable memory, and
a first server network connection,
transmitting a request for the wireless signal records and the play logs to the first server database from a second server comprising
a second server processor, and
a second server network connection,
receiving the wireless signal records and the play logs from the first server through the second server network connection into the second server processor,
deleting by the second server processor the wireless signal records having a difference between the starting time and the ending time shorter than a minimum duration value,
calculating by the second server processor the number of relevant wireless signals proximate to the advertisement display during each advertisement by comparing the starting time and ending time of each remaining wireless signal record to the play logs,
for each advertisement, multiplying by the second server processor the number of relevant wireless signals by a sensor adjustment value, thereby generating an advertisement reach value, and
transmitting the advertisement reach value through the second server network connection to the first server.

7. The method of claim 6, wherein the advertisement display is a newsstand.

8. The method of claim 6, further comprising:
calculating by the advertising display processor the number of relevant wireless signals proximate to the advertisement display during each advertisement by comparing the starting time and ending time of each wireless signal record to the play logs.

9. The method of claim 6, wherein the advertisement database further comprises:
identity data of factors to include in schedule generation, and
URLs where the values of the factors are found;
the method further comprising:
transmitting a request from the advertising display processor to the advertisement database for the identity data of the factors and the URLs where the values are found,
receiving the identity data and the URLs into the advertisement display processor,
storing the identity data and the URLs in the advertisement display memory,
transmitting a request from the advertisement display processor to each URL for the values of the factors, and
receiving the values of the factors;
and wherein the step of generating by the advertising display processor a display schedule for the at least one video advertisement includes calculating the relative importance of the at least one video advertisement compared to the values of the factors.

10. The method of claim 6, further comprising:
transmitting a request for electronic data from the first server,
receiving the electronic data from the first server,
formatting the electronic data for display, and
transmitting the formatted electronic data to a data display output device, and
displaying by the data display output device to formatted electronic data.
